(19) United States
(12) Patent Application Publication
(10) Pub. No.: US 2024/0134891 A1
(43) Pub. Date: Apr. 25, 2024

(54) COMPUTER-READABLE RECORDING MEDIUM STORING DETERMINATION PROGRAM, DETERMINATION METHOD, AND INFORMATION PROCESSING APPARATUS

(71) Applicant: FUJITSU LIMITED, Kawasaki-shi (JP)

(72) Inventor: Tatsuya YAMAMOTO, Kawasaki (JP)

(73) Assignee: FUJITSU LIMITED, Kawasaki-shi (JP)

(21) Appl. No.: 18/532,130

(22) Filed: Dec. 7, 2023

Related U.S. Application Data
(63) Continuation of application No. PCT/JP21/24094, filed on Jun. 25, 2021.

(51) Int. Cl. G06F 16/31; G06F 3/01

(52) U.S. Cl. CPC G06F 16/313; G06F 3/011; G06F 2203/011

(57) ABSTRACT

A non-transitory computer-readable recording medium stores a determination program causing a computer to execute a processing of: determining, based on at least one of an opinion of respective users with respect to a specific topic and information regarding an approval or a disapproval of the respective users for an opinion of another person with respect to the specific topic, a tendency of a change in an index value indicating a degree of positive emotions of the users; and outputting, when detecting a first tendency and a second tendency in which a difference between the first tendency and the second tendency is equal to or less than a threshold value, a first user corresponding to the first tendency and a second user corresponding to the second tendency from among the users as third users included in a target group.

### CROSS-REFERENCE TO RELATED APPLICATION

This application is a continuation application of International Application PCT/JP2021/024094 filed on Jun. 25, 2021 and designated the U.S., the entire contents of which are incorporated herein by reference.

### FIELD

The present disclosure relates to a determination program.

### BACKGROUND

A majority and a minority may occur in various scenes such as a discussion on a community such as Social Networking Service (SNS), a discussion in a Web conference, or a place where an opinion about a certain topic or theme is posted. In order to specify the minority or the majority, an analysis method using a questionnaire is used, and in recent years, a negative/positive analysis of an opinion on a specific topic is known.

Related art is disclosed in Non-patent literature: “Extracting Semantic Orientations of Words using Spin Model” by Hiroya Takamura, Takashi Inui and Manabu Okumura.

### SUMMARY

Minority users hide or weaken their opinions. There are also variations in the same positive and negative. For this reason, it is not possible to draw a true opinion of the user by a technique of determining whether a simple opinion is positive or negative with respect to the specific topic. Therefore, in the above-described technique, there is a case where users having similar opinions on the specific topic may be specified from among a plurality of users.

One aspect of the disclosure is to provide a determination program, a determination method, and an information processing apparatus capable of specifying users having similar opinions.

According to an aspect of the embodiments, a non-transitory computer-readable recording medium stores a determination program causing a computer to execute a processing of: determining, based on at least one of an opinion of respective users with respect to a specific topic and information regarding an approval or a disapproval of the respective users for an opinion of another person with respect to the specific topic, a tendency of a change in an index value indicating a degree of positive emotions of the users; and outputting, when detecting a first tendency and a second tendency in which a difference between the first tendency and the second tendency is equal to or less than a threshold value, a first user corresponding to the first tendency and a second user corresponding to the second tendency from among the users as third users included in a target group.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an overall configuration example of a system according to a first embodiment;

FIG. 2 is a diagram for explaining an extraction of a change in opinion according to the first embodiment;

FIG. 3 is a functional block diagram illustrating a functional configuration of the information processing apparatus according to the first embodiment;

FIG. 4 is a diagram illustrating an example of user information stored in a user information DB;

FIG. 5 is a diagram illustrating an example of information stored in a keyword DB;

FIG. 6 is a diagram illustrating an example of information stored in a posted information DB;

FIG. 7 is a diagram for explaining a strong tuning signal;

FIG. 8 is a diagram for explaining a detection of the strong tuning signal;

FIG. 9 is a diagram for explaining a determination method 1 of the strong tuning signal;

FIG. 10 is a diagram for explaining a method 2 of determining the strong tuning synchronization signal;

FIG. 11 is a diagram for explaining a weak tuning signal;

FIG. 12 is a diagram for explaining a method of determining the weak tuning signal;

FIG. 13 is a diagram for explaining a detection of a tuning user;

FIG. 14 is a diagram for explaining a detection of a protection target user;

FIG. 15 is a flowchart illustrating a flow of processing according to the first embodiment;

FIG. 16 is a diagram illustrating an example of a hardware configuration.

### DESCRIPTION OF EMBODIMENTS

Hereinafter, embodiments of a determination program, a determination method, and an information processing apparatus according to the present disclosure will be described in detail with reference to the drawings. However, the present disclosure is not limited to these embodiments. In addition, each of the embodiments may be appropriately combined within a range in which there is no contradiction.

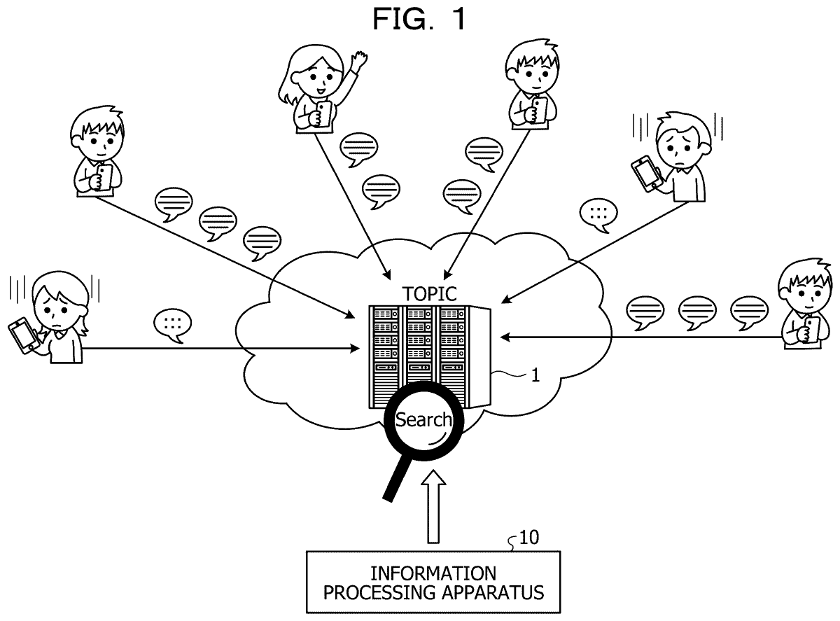

FIG. 1 is a diagram for explaining an overall configuration example of a system according to a first embodiment. As illustrated in FIG. 1, the system is a system in which a server 1 and an information processing apparatus 10 are coupled to each other by wire or wirelessly.

The server 1 is an example of a computer that provides topics to a plurality of users and provides a discussion place in which each user posts an own opinion using an SNS, a web browser or the like. Note that the discussion is not limited to the discussion performed in real time, and for example, minutes of the discussion may be used.

The information processing apparatus 10 is an example of a computer that analyzes an opinion posted by each user and detects a majority corresponding to an opinion of a majority or a minority corresponding to an opinion of a minority, thereby generating information leading to follow-up of each user or activation of a future discussion.

In general, in a discussion, a user corresponding to majority and a user corresponding to minority may occur. The user corresponding to the minority receives a tuning pressure due to the majority, may change own opinion due to influence of losing confidence or the like and has a great stress. On the other hand, it is known that a user corresponding to a minority having a common point may influence and counteract the majority by uniting the users. Note that, in the present embodiment, a user corresponding to the majority may be simply referred to as a “majority user”, a user corresponding to the minority may be simply referred to as a “minority user” or the like.

For example, there are two groups of the minority on the community, “a minority group which has already been united and can oppose” and “a minority group which has not been united and unilaterally feels stress in the community”. Therefore, detecting and following up a user of the minority who feels stress, grouping users who similarly feel stress so as to easily participate in a discussion, or the like leads to an activation of the discussion and a provision of an effective field of the discussion.

As a method of detecting the minority, a negative/positive analysis using a negative degree or a positive degree set for a keyword in a posted opinion is known. However, since the minority rarely gives an opinion except for a small number of strong minority who can give an opinion, it is difficult to grasp the entire opinion of the minority in the negative/positive analysis. Also, an opinion that changes across negative and positive is a very dramatic change, and the negative/positive analysis is not suitable for observing the minority.

Therefore, the information processing apparatus 10 according to the first embodiment formulates behavioral characteristics of the minority and automatically extracts the minority based on behavioral characteristics analysis of the minority based on social psychology.

For example, the information processing apparatus 10 determines a tendency of a change in index values indicating a degree of a plurality of positive emotions of the plurality of users based on at least one of an own opinion of each of the plurality of users with respect to the specific topic and information regarding an approval or a disapproval of an opinion of another person with respect to the specific topic. When the information processing apparatus 10 detects a first tendency and a second tendency in which a difference therebetween is equal to or less than a threshold value from among the plurality of tendencies of change in the index value indicating the degree of positive emotion, the information processing apparatus 10 outputs a first user corresponding to the first tendency and a second user corresponding to the second tendency from among the plurality of users as users included in a target group.

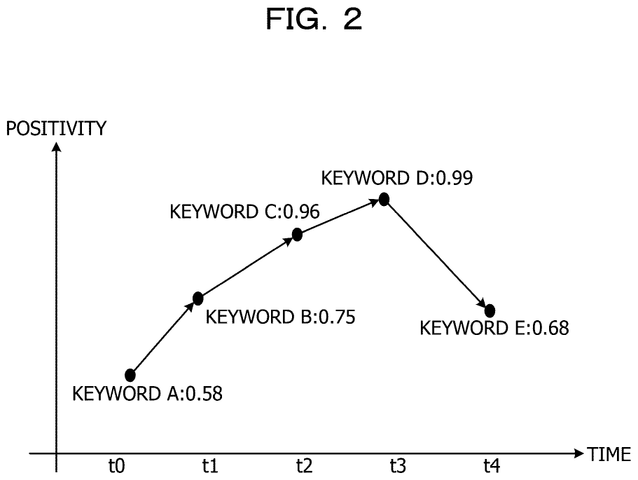

FIG. 2 is a diagram for explaining an extraction of a change in opinion according to the first embodiment. FIG. 2 illustrates a change in the positive degree by indicating a transition of a keyword having the highest positive degree included in an opinion posted by a certain user or a transition of a keyword having the highest positive degree included in an opinion of another person to whom the certain user has turned (synchronized). For example, referring to FIG. 2, it is illustrated that among the keywords included in the opinions posted in the vicinity of time t0 among each of the opinions posted between time t0 and time t1, the keyword A has the highest positive degree (0.58).

As illustrated in FIG. 2, from time t0 to time t4, the opinion of the certain user changes within a positive range, but from time t3 to time t4, the opinion is positive but changes from high positive to low positive. Since typical negative/positive analysis detects dramatic changes from positive to negative, such changes within the positive are consistently analyzed as a positive state.

On the other hand, the information processing apparatus 10 according to the first embodiment appropriately detects a positive reaction and a negative reaction of the minority which are constantly changing. For example, the information processing apparatus 10 detects a fine change in a signal of the user by determining a small repetition of the vertical movement in the positive range or the negative range as a number of changes using definition information of the keyword. As a result, the information processing apparatus 10 may determine a plurality of tendencies in a change in the positive emotion or the negative emotion, realize grouping of users having the same change with each other, and specify users having similar opinions.

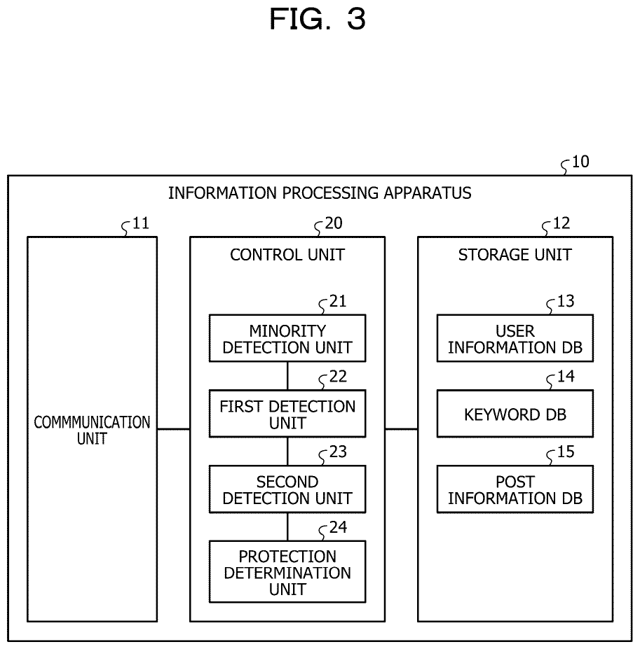

FIG. 3 is a functional block diagram illustrating a functional configuration of the information processing apparatus 10 according to the first embodiment. As illustrated in FIG. 3, the information processing apparatus 10 includes a communication unit 11, a storage unit 12, and a control unit 20.

The communication unit 11 controls communication with other devices. For example, the communication unit 11 acquires an opinion (post) of each user on a certain topic from the server 1, and transmits an analysis result or the like to a terminal of an administrator.

The storage unit 12 stores various data, a program executed by the control unit 20, and the like. For example, the storage unit 12 stores user information DB 13, a keyword DB 14, and post information DB 15.

The user information DB 13 is a database that stores information on users who post opinions in a discussion place. For example, the user information DB 13 stores information of employees participating in a discussion in the discussion place such as a company, and stores information of online users in the case of an SNS or the like.

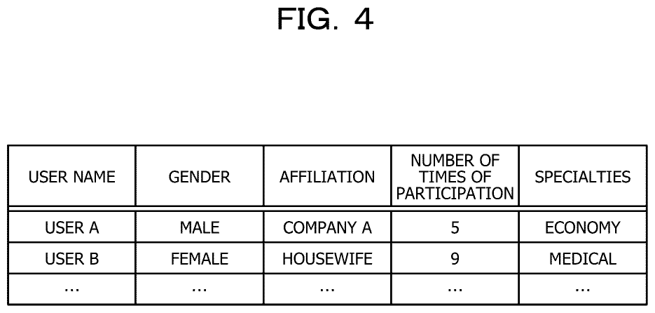

FIG. 4 is a diagram illustrating an example of user information stored in the user information DB 13. As illustrated in FIG. 4, the user information DB 13 stores, for one example, “user name, gender, affiliation, number of times of participation, specialties” and the like. In the “user name” stored here, a name of a user such as a real name, a penname, or a name called in SNS is registered. Information indicating a male or a female is registered in the “gender”. In the “affiliation”, an affiliation destination such as a company employee or a department is registered. The number of times of participation in a discussion is registered in the “number of times of participation”. In the “specialties”, specialties at which the user is good are registered. In the example of FIG. 4, as information of “user A”, it is registered that “user A” is “male”, belongs to “company A”, has participated “five times” so far, and has the specialties of “economy”.

The keyword DB 14 is a database that stores information in which keywords and indicator values indicating positive degrees are associated with each other. For example, the keyword DB 14 stores a value indicating an indicator value calculated by a known method for each word (keyword) used in a posted opinion.

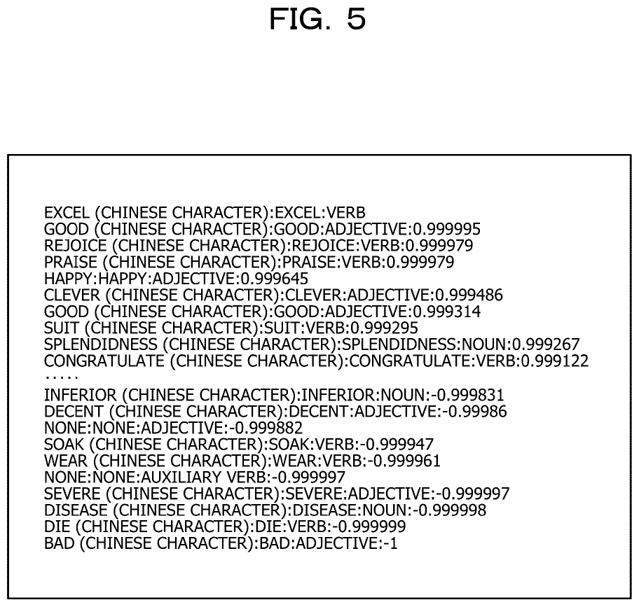

FIG. 5 is a diagram illustrating an example of information stored in a keyword DB 14. As illustrated in FIG. 5, the keyword DB 14 stores “keyword, index value” in association with each other. In the “keyword”, a word or a part of speech is registered. In the “index value”, information obtained by quantifying a positive degree that is a degree of positive emotion of the user is registered. This “index value” is a value from 1 to −1, and becomes a larger value as the possibility of being used with a positive opinion is higher. Note that as the “index value”, a value described in an emotion analysis dictionary, a word emotion polarity correspondence table, or the like may be employed. In the example of FIG. 5, for the keyword “good”, it is registered that the index value is “0.999995” and the keyword is often used in a positive opinion. On the other hand, for the keyword “wear”, it is registered that the index value is “−0.999961”, the negative degree is high and the keyword is often used for a negative opinion.

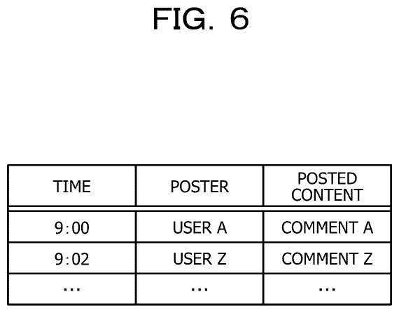

The posted information DB 15 is a database that stores information related to opinions posted by each user. The information stored here may be information periodically acquired by the communication unit 11 or information input by the administrator or the like. FIG. 6 is a diagram illustrating an example of information stored in the posted information DB 15. As illustrated in FIG. 6, the posted information DB 15 stores, as one example, “time, poster, posted content”. In the “time” stored here, the time when the opinion is posted is registered. Information for specifying a user who has posted the opinion is registered in the “poster”. The posted content is registered in the “posted content”. In the example of FIG. 6, it is registered that “user A” posted “comment A” at “9:00”.

Note that the posted information DB 15 may further store information of other users who have tuned in, in association with the opinion of each user. For example, the posted information DB 15 further associates “turning information” in which the turned user X or user Y is registered with respect to “time, poster, posted content”. Note that the control unit 20 may detect or specify a user who has tuned to the opinion of a certain user by acquiring a button operation or the like to be pressed when tuning to the opinion of the certain user.

The control unit 20 is a processing unit that controls the entire information processing apparatus 10. For example, the control unit 20 includes a minority detection unit 21, a first detection unit 22, a second detection unit 23, and a protection determination unit 24.

The minority detection unit 21 detects the minority user based on an opinion posted on a topic. For example, the minority detection unit 21 determines whether or not each user corresponds to the minority by comparing the number of posted opinions with a threshold or by using the bias of the posted opinions. Then, the minority detection unit 21 detects the corresponding user as the minority user, stores the corresponding user in the storage unit 12, and outputs the corresponding user to another processing unit.

For example, the minority detecting unit 21 detects, as the minority user, a user whose number of posted opinions is less than a threshold, a user whose posting interval is less than a threshold, a user whose difference between the number of posted opinions and an average value of all users is greater than or equal to a threshold, a user whose difference between the posting interval and an average value of all users is greater than or equal to a threshold or the like.

In addition, the minority detection unit 21 specifies a maximum value of the index value among the opinions posted by each user based on the information stored in the keyword DB 14. Then, the minority detection unit 21 calculates a variance or a standard deviation of the maximum value of the index value of each user, and detects a user whose difference between the maximum value and the variance is equal to or greater than a threshold or a user whose standard deviation is equal to or greater than a threshold as a minority. Note that not only the maximum value but also an average value of the index value of each user or the like may be used, and the average value may be combined with the number of opinions. As described above, the minority detection unit 21 may detect the minority user by using a known method.

The first detection unit 22 observes a direct change in an opinion posted by a user, and detects a strong tuning signal corresponding to a trigger or sign for turning to another user. For example, the first detection unit 22 determines the tendency of the change in the index values indicating the degrees of the plurality of positive emotions of the plurality of users based on the change in the respective own opinions of the plurality of users with respect to the specific topic.

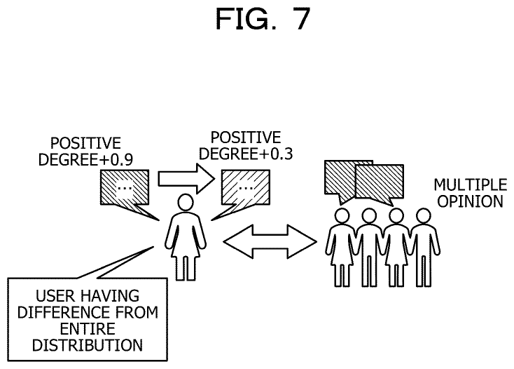

FIG. 7 is a diagram for explaining a strong tuning signal. As illustrated in FIG. 7, the first detection unit 22 calculates the index related to the change in the opinion in which the index value decreases by a certain value in the positive although the index value does not drastically change from the positive to the negative as in the case where the index value changes from “+0.9” to “+0.3”, for the user having a difference from the entire distribution. The user having the difference from the entire distribution is an example of the minority user detected by the minority detection unit 21.

For example, the first detection unit 22 refers to the posted information DB 15 and extracts an opinion posted by the user X on a certain topic. The first detection unit 22 refers to the keyword DB 14 and sets the keyword α having the maximum index value among the keywords included in the opinion as a value representing the opinion. This is intended to attract a strong opinion by representing a value having a large absolute value in a state in which the negative and the positive are mixed. Then, the first detection unit 22 sets a window (time interval T) for capturing a change in the opinion within the certain period T, shifts the window by +1 in the time axis direction, and acquires the degree of change in the opinion and the number of changes before and after within the time interval T.

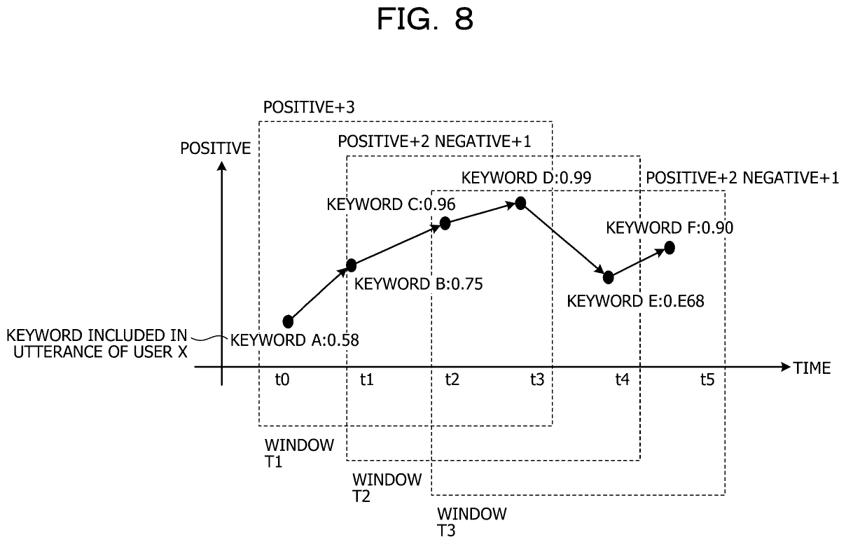

FIG. 8 is a diagram for explaining a detection of a strong turning signal. As illustrated in FIG. 8, the first detection unit 22 specifies a keyword A (index value: 0.58) having the maximum index value among the keywords included in the opinions posted near time to, and specifies a keyword B (index value: 0.75) having the maximum index value among the keywords included in the opinions posted near time t1. Similarly, the first detection unit 22 specifies a keyword C (index value: 0.96) having the maximum index value among the keywords included in the opinions posted near time t2, and specifies a keyword D (index value: 0.99) having the maximum index value among the keywords included in the opinions posted near time t3. The first detection unit 22 specifies a keyword E (index value: 0.68) having the maximum index value among the keywords included in the opinions posted near time t4, and specifies a keyword F (index value: 0.90) having the maximum index value among the keywords included in the opinions posted near time t5.

Then, the first detection unit 22 calculates a number of transitions to the positive as 3 in the range of the window “T1” because all the maximum index values increase. Since the maximum index value increases twice and decreases once in the range of the window “T2” and the range of the window “T3”, the first detection unit 22 calculates the number of transitions to the positive as 2 and a number of transitions to the negative as 1.

Thereafter, the first detection unit 22 calculates “S_{T}” indicating a change in the opinion for each time interval T (window) using Equation 1. As illustrated in Equation (1), “S_{T}” is calculated by multiplying “αᵢ₊₁−αᵢ” indicating “a sum of differences before and after the index values of n opinions in the window” by “Wᵢ” indicating “ a sum of a numbers of inversions of the index values in the window”.

$$[ Equation 1 ]$$

$${S}_{T} = {\{ {\sum }_{i}^{n} \vert {α}_{i + 1} - {α}_{i} \vert \cdot {\sum }_{i}^{n} {W}_{i} \}}_{T} \qquad EQUATION ( 1 )$$

Note that “−1” is set to “Wi” when “Bi” is smaller than 0, and “a value of Bi” is set to “Wi” when “Bi” is equal to or larger than 0, as illustrated in Equation (2). As illustrated in equation (3), “Bi” is a value that is switched depending on a sign of a starting point from which the difference is calculated and a sign of the difference, and is “αᵢ₊₁−αᵢ” if the index value of the starting point “αᵢ” is a positive value (plus), and “−(αᵢ₊₁−αᵢ)” if the index value of the starting point “αᵢ” is a negative value (minus).

$$[ Equation 2 ]$$

$${W}_{i} = \{ \begin{matrix}- 1 , & {B}_{i} < 0 \\ {B}_{i} , & {B}_{i} \geq 0\end{matrix} \qquad EQUATION ( 2 )$$

$$[ Equation 3 ]$$

$${B}_{i} = sgn ( {α}_{i} ) \cdot ( {α}_{i + 1} - {α}_{i} ) \qquad EQUATION ( 3 )$$

Then, the first detection unit 22 calculates an average value of “S_{T}” calculated in each window. Thereafter, the first detection unit 22 calculates the variance as the tendency of the change in the index values indicating the degrees of the plurality of positive emotions by Equation (4) using the difference between each “S_{T}” and the average value. The first detection unit 22 stores the calculated variance in the storage unit 12 and outputs the calculated variance to the protection determination unit 24.

$$[ Equation 4 ]$$

$$VARIANCE S = \frac{1}{N} {\sum }_{i}^{N} {( {S}_{i} - \overline{S} )}^{2} \qquad EQUATION ( 4 )$$

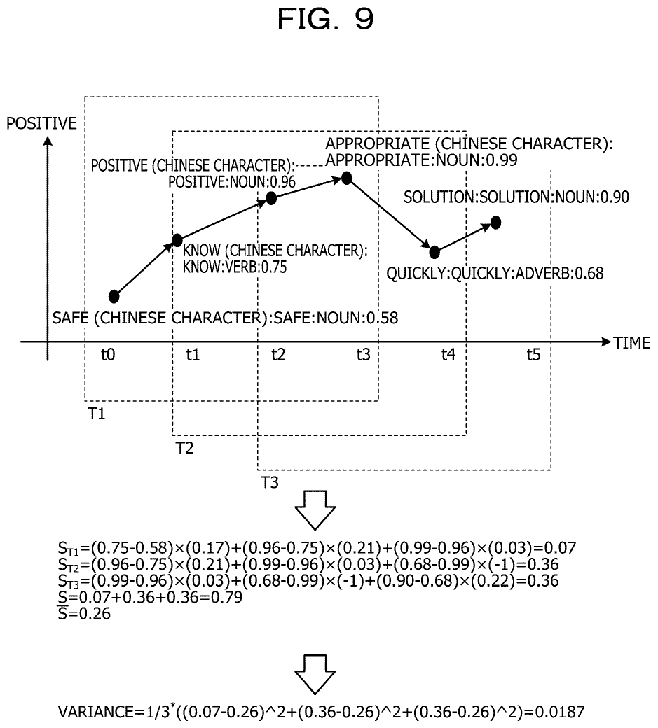

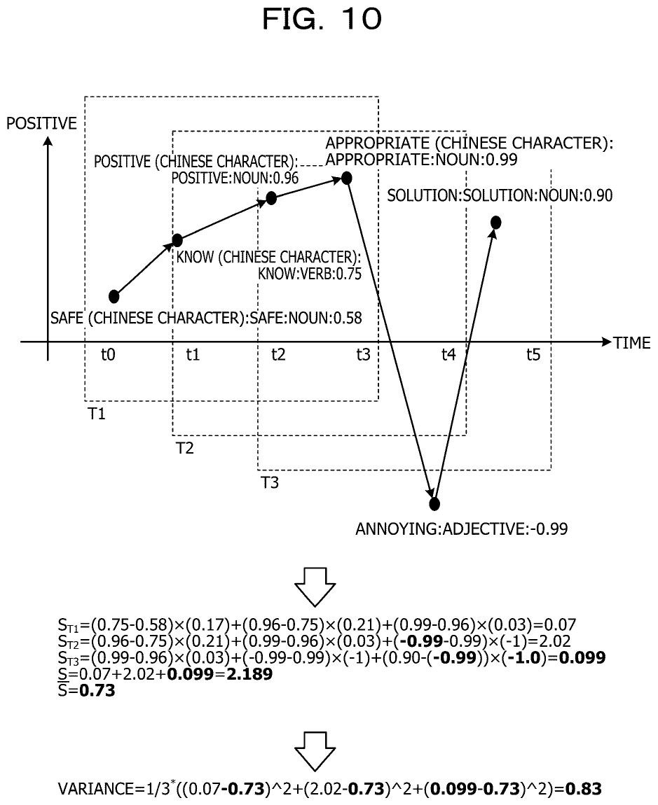

A specific example will now be described with reference to FIGS. 9 and 10. The first detection unit 22 may also determine the tendency of the change in the index value within a range of positive values of the index value and within a range of positive opinions. As another example, the first detection unit 22 may determine the tendency of the change in the index value within a range of the index value from a positive value to a negative value and including a positive opinion to a negative opinion. Therefore, specific examples of each will be described with reference to FIGS. 9 and 10.

FIG. 9 is a diagram explaining a determination method 1 of the strong tuning signal, and FIG. 10 is a diagram explaining illustrating a determination method 2 of the strong tuning signal. Although an example in which there are three windows (T1, T2, and T3) will be described, the number of windows is not limited.

First, with reference to FIG. 9, a description will be given of an example in which the first detection unit 22 detects a strong turning signal indicating a tendency of change in an index value within a range of positive opinions. The first detection unit 22 calculates “Sₜ₁” indicating a change in the opinion posted by the user X for the window (T1) from time t1 to t3 illustrated in FIG. 9. For example, as illustrated in FIG. 9, the first detection unit 22 specifies the index value “0.58” of the noun “safe” among the keywords of the opinions posted near time t0. The first detection unit 22 specifies the index value “0.75” of the verb “know” for the opinions posted near time t1. The first detection unit 22 specifies the index value “0.96” of the noun “positive” for the opinions posted near time t2. The first detection unit 22 specifies the index value “0.99” of the noun “appropriate” for the opinions posted near time t3.

Then, the first detection unit 22 calculates a change in each window using Equation (2) and Equation (3). For example, as illustrated in FIG. 9, the first detection unit 22 calculates a difference “0.75−0.58=0.17” between the keywords “know” and “safe”. At this time, since the index value “0.58” of the keyword “safe” at the start point and the difference is a positive value, the first detection unit 22 sets the difference “0.17” to “W₁”. Similarly, the first detection unit 22 calculates the difference “0.96−0.75=0.21” between the keywords “positive” and “know”, and sets the difference “0.21” to “W₂” because the index value “0.75” of the keyword “know ” at the start point and the difference is a positive value. In addition, the first detection unit 22 calculates a difference “0.99−0.96=0.03” between the keywords “appropriate” and “positive”, and sets the difference “0.03” to “W₃” because the index value “0.96” of the keyword “positive” at the start point and the difference is a positive value.

As these result, the first detection unit 22 calculates “S_{T1}” with respect to T1 using Equation (1). For example, as illustrated in FIG. 9, the first detection unit 22 calculates “S_{T1}=(0.75−0.58)×(0.17)+(0.96−0.75)×(0.21)+(0.99−0.96)×(0.03)=0.07”.

Next, the first detection unit 22 calculates “S_{T2}” indicating a change in the opinion posted by the user X for the window (T2) from time t1 to time t4 illustrated in FIG. 9. For example, as illustrated in FIG. 9, the first detection unit 22 newly specifies the index value “0.68” of the adverb “quickly” for the opinions posted near time t4 in addition to the above-described content.

Then, the first detection unit 22 calculates a change in each window using Equation (2) and Equation (3). For example, as illustrated in FIG. 9, the first detection unit 22 newly calculates a difference “0.68−0.99=−0.31” between the keywords “quickly” and “ appropriate ” in addition to the above-described content. At this time, since the index value “0.99” of the keyword “appropriate” at the start point is a positive value and the difference is a negative value, the first detection unit 22 sets “−1” to “W₄” based on Equation (2).

As these result, the first detection unit 22 calculates “ST2” with respect to T2 using Equation (1). For example, as illustrated in FIG. 9, the first detection unit 22 calculates “S_{T2}=(0.96−0.75)×(0.21)+(0.99−0.96)×(0.03)+(0.68−0.99)×(−1)=0.36”.

Next, the first detection unit 22 calculates “Sₜ₃” indicating a change in the opinion posted by the user X for the window (T3) from time T3 to time t5 illustrated in FIG. 9. For example, as illustrated in FIG. 9, the first detection unit 22 newly specifies the index value “0.90” of the noun “solution” for the opinions posted near time t5 in addition to the contents described above.

Then, the first detection unit 22 calculates a change in each window using Equation (2) and Equation (3). For example, as illustrated in FIG. 9, the first detection unit 22 newly calculates a difference “0.90−0.68=0.22” between the keywords “solution” and “quickly” in addition to the above-described content. At this time, since the index value “0.68” and the difference of the keyword “quickly” at the start point are positive values, the first detection unit 22 sets the difference “0.22” to “W₅”.

As these result, the first detection unit 22 calculates “S_{T3}” with respect to T3 using Equation (1). For example, as illustrated in FIG. 9, the first detection unit 22 calculates “S_{T3}=(0.99−0.96)×(0.03)+(0.68−0.99)×(−1)+(0.90−0.68)×(0.22)=0.36”.

After that, the first detection unit 22 calculates the average value “0.26” and the total value “0.79” of “S_{T1}”, “S_{T2}”, and “S_{T3}”. Then, the first detection unit 22 calculates the variance “0.0187” by Equation (1) using “S_{T1}=0.07”, “S_{T2}=0.36”, “S_{T3}=0.36”, and the average value “0.26”.

Next, with reference to FIG. 10, a description will be given of an example in which the first detection unit 22 detects a strong turning signal that is a tendency of a change in the index value within a range from the positive to the negative. The first detection unit 22 calculates “S_{T1}” indicating a change in the opinion posted by the user X for the window (T1) from time t0 to t3 illustrated in FIG. 10. For example, as illustrated in FIG. 10, the first detection unit 22 specifies the index value “0.58” of the noun “safe” for the opinions posted near time t0. The first detection unit 22 specifies the index value “0.75” of the verb “know” for the opinions posted near time t1. The first detection unit 22 specifies the index value “0.96” of the noun “positive” for the opinions posted near time t2. The first detection unit 22 specifies the index value “0.99” of the noun “appropriate” for the opinions posted near time t3.

Then, the first detection unit 22 calculates a change in each window using Equation (2) and Equation (3). For example, as illustrated in FIG. 10, the first detection unit 22 calculates a difference “0.75−0.58=0.17” between the keywords “know” and “safe”, and sets the difference “0.17” to “W₁”. Similarly, the first detection unit 22 calculates a difference “0.96−0.75=0.21” between the keywords “positive” and “know”, and sets the difference “0.21” to “W₂”. In addition, the first detection unit 22 calculates a difference “0.99−0.96=0.03” between the keywords “appropriate” and “positive”, and sets the difference “0.03” to “W₃”.

As these result, the first detection unit 22 calculates “S_{T1}” with respect to T1 using Equation (1). For example, as illustrated in FIG. 10, the first detection unit 22 calculates “S_{T1}=(0.75−0.58)×(0.17)+(0.96−0.75)×(0.21)+(0.99−0.96)×(0.03)=0.07”.

Next, the first detection unit 22 calculates “S_{T2}” indicating a change in the opinion posted by the user X with respect to the window (T2) from time T2 to time t4 illustrated in FIG. 10. For example, as illustrated in FIG. 10, the first detection unit 22 newly specifies the indicator value “−0.99” of the adjective “annoying” with respect to the posted opinions posted near time t4 in addition to the above-described content.

Then, the first detection unit 22 calculates a change in each window using Equation (2) and Equation (3). For example, as illustrated in FIG. 10, the first detection unit 22 newly calculates a difference “−0.99−0.99=1.98” between the keywords “annoying” and “appropriate” in addition to the above-described content, and sets “−1” to “W₄” based on Equation (2).

As these result, the first detection unit 22 calculates “S_{T2}” with respect to T2 using Equation (1). For example, as illustrated in FIG. 10, the first detection unit 22 calculates “S_{T2}=(0.96−0.75)×(0.21)+(0.99−0.96)×(0.03)+(−0.99−0.99)×(−1)=2.02”.

Next, the first detection unit 22 calculates “Sₜ₃” indicating a change in the opinion posted by the user X with respect to the window (T3) from time T3 to time t5 illustrated in FIG. 10. For example, as illustrated in FIG. 10, the first detection unit 22 newly specifies the index value “0.90” of the noun “solution” for the opinion posted near time t5 in addition to the above-described content.

Then, the first detection unit 22 calculates a change in each window using Equation (2) and Equation (3). For example, as illustrated in FIG. 10, the first detection unit 22 newly calculates a difference “0.90−(−0.99)=1.89” between the keywords “solution” and “annoying” in addition to the above-described content, and sets “−1” to “W₅” based on Equation (2).

As these result, the first detection unit 22 calculates “S_{T3}” with respect to T3 using Equation (1). For example, as illustrated in FIG. 10, the first detection unit 22 calculates “S_{T3}=(0.99−0.96)×(0.03)+(−0.99−0.99)×(−1)+(0.90−(−0.99))×(−1)=0.099”.

After that, the first detection unit 22 calculates the average value “0.73” and the total value “2.189” of “S_{T1}”, “S_{T2}”, and “S_{T3}”. Then, the first detection unit 22 calculates the variance “0.83” by Equation (1) using “S_{T1}=0.07”, “S_{T2}=2.02”, “S_{T3}=0.099”, and the average value “0.73”.

Referring back to FIG. 3, the second detection unit 23 detects a weak turning signal corresponding to a reaction to another person by paying attention to an agreement to another person's opinion and observing a change in an index value of the another person's opinion. For example, the second detection unit 23 determines the tendency of the change in the index values indicating the degrees of the plurality of positive emotions of the plurality of users based on information related to an approval or a disapproval of the opinions of other people with respect to the specific topic.

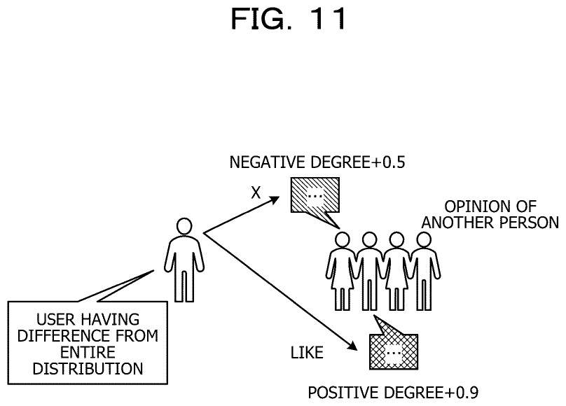

FIG. 11 is a diagram for explaining a weak tuning signal. As illustrated in FIG. 11, the second detection unit 23 calculates an index related to an operation (for example, an operation of posting “like!” to the opinion of another person) for turning to the opinion of another person having an index value of “0.9” not the opinion of another person having a negative degree (synonymous with a minus positive degree) of “0.5” for a user having a difference from the entire distribution.

For example, the second detection unit 23 refers to the posted information DB 15 and extracts the opinions of other people who the user X agrees with among the total number M of opinions. The second detection unit 23 refers to the keyword DB 14 and sets the keyword a having the maximum index value among the keywords included in the opinion agreed by the user X as a value representing the opinion. In this way, the second detection unit 23 generates information in which an agreement flag (sⱼ=1) indicating that the user X agrees or an agreement flag (sⱼ=0) indicating that the user X does not agree is set for the M opinions of other people other than the user X, and stores the information in the storage unit 12 or the like.

Then, the second detection unit 23 calculates the total values “Uⱼ” of the keywords βⱼ to which the agreement flag (sⱼ=1) indicating that the user X agrees is set using Equation (5). In addition, the second detection unit 23 calculates an average value of the total values “Uⱼ”. Thereafter, the second detection unit 23 calculates the variance “U” that is a tendency of change in the index values indicating the degrees of the plurality of positive emotions of the plurality of users using Equation (6). Unlike the strong tuning signal, since posting an opinion by another person and agreeing with an opinion of another person are done asynchronously the window is not set. In addition, the second detection unit 23 stores the calculated variance in the storage unit 12 and outputs it to the protection determination unit 24.

$$[ Equation 5 ]$$

$$\begin{matrix}{U}_{j} = {\sum }_{j}^{M} {β}_{j} \cdot {s}_{j} & {S}_{j} \{ \begin{matrix}+ 1 , THERE IS \\ AGREEMENT \\ FLAG FOR OPINIONS \\ INCLUDING {B}_{J} . \\ 0 , THERE IS NO \\ AGREEMENT FLAG \\ FOR OPINIONS \\ INCLUDING {B}_{J} .\end{matrix}\end{matrix} \qquad EQUATION ( 5 )$$

$$[ Equation 6 ]$$

$$VARIANCE U = \frac{1}{M} {\sum }_{i}^{M} {( {U}_{i} - \overline{U} )}^{2} \qquad EQUATION ( 6 )$$

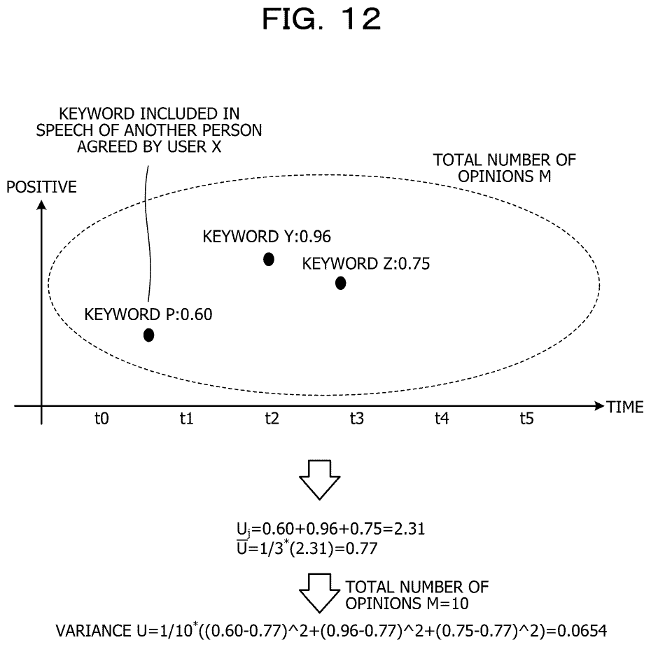

Here, a specific example will be described with reference to FIG. 12. FIG. 12 is a diagram illustrating a method of determining a weak tuning signal. Although an example in which opinions posted until the time t5 are used will be described, the time range or the like is not limited.

First, as illustrated in FIG. 12, the second detection unit 23 counts the total number M of opinions. The total number of opinions may be a total number of opinions of all other users other than the user X who is a target minority, a total number including the opinion of the user X, or a total number of opinions posted by majority users.

Next, the second detection unit 23 specifies three opinions agreed by the user X among the M opinions, and specifies a keyword having a maximum index value from each opinion. For example, the second detection unit 23 specifies a keyword P having an index value of “0.60”, a keyword Y having an index value of “0.96”, and a keyword Z having an index value of “0.75”.

Then, the second detection unit 23 calculates the total value of the index values “0.60+0.96+0.75=2.31” and the average value of the index values “2.31/3=0.77”. When the total number of opinions M=10, the second detection unit 23 calculates the variance U “0.0654” using Equation (6).

Referring back to FIG. 3, the protection determination unit 24 determines, for each user, the presence or absence of a minority user who is in the same situation. For example, the protection determination unit 24 detects a first tendency and a second tendency in which a difference is equal to or less than a threshold value from among a plurality of tendencies of change in the index value indicating the degree of positive emotion. Then, the protection determination unit 24 outputs the first user corresponding to the first tendency and the second user corresponding to the second tendency as users included in the target group.

For example, the protection determination unit 24 calculates, for each user of the minority, the tuning index (conformity) by Equation (7) using the variance for the strong tuning signal (Equation 4) and the variance for the weak tuning signal (Equation 6). Then, the protection determination unit 24 groups users having similar tuning indexes (hereinafter, referred to as tuning users in some cases) into a group that feels similar stress. Note that the group that feels similar stress is an example of a group of tuning users or a group of tuning stress.

$$[ Equation 7 ]$$

$$\begin{matrix}C ( Conformity ) = VARIANCE S OVER TRACE \\ RANGE + VARIANCE U OF \\ ENTIRE TOTAL NUMBER \\ OF OPINIONS M \\ = \frac{1}{N} {\sum }_{i}^{N} {( {S}_{i} - \overline{S} )}^{2} + \frac{1}{M} {\sum }_{i}^{M} {( {U}_{i} - \overline{U} )}^{2}\end{matrix} \qquad EQUATION ( 7 )$$

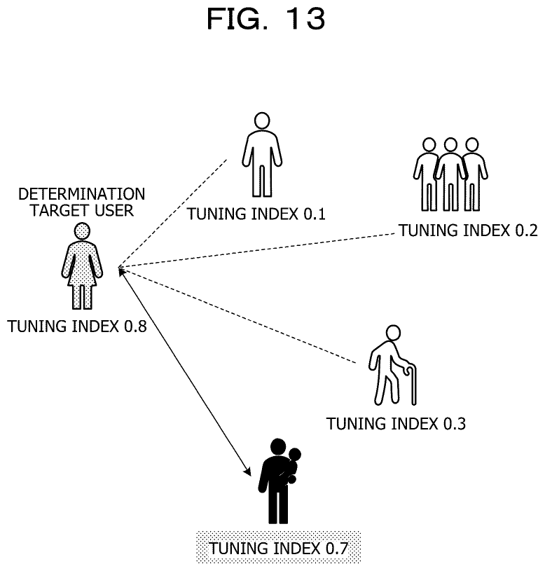

FIG. 13 is a diagram illustrating a detection of a tuning user. As illustrated in FIG. 13, the protection determination unit 24 determines that each of the users of the minority in which the difference between the tuning indexes is less than the threshold value belongs to the same group (binding group). In the example of FIG. 13, with respect to the determination target user whose tuning index is “0.8”, the protection determination unit 24 groups the users whose tuning index is “0.7” in which the difference is less than the threshold value as users who feel the same stress. In addition, the protection determination unit 24 may determine that the users of the minority in which the number of repetitions of the turning opinion is equal to or greater than a threshold value belong to the same group, and may determine that the users satisfying both the difference between the tuning indexes and the number of repetitions of the tuning opinion belong to the same group.

In addition, the protection determination unit 24 may refer to the user information DB 13 and use a relationship (connection) between users as a determination material. For example, the protection determination unit 24 may use the same sex, the same affiliation or the same specialties, the similarity in affiliation or specialties, or the like as the determination condition.

Furthermore, the protection determination unit 24 notifies each user belonging to the same group that the users may collectively post opinions, and causes each user to recognize with each other that there are users in the same environment. Thus, the protection determination unit 24 may prompt the users to post opinions more actively than usual, and may activate the discussion. In addition, it may be expected that such a user is bound as a minority having a common point, thereby affecting the majority and activating the discussion.

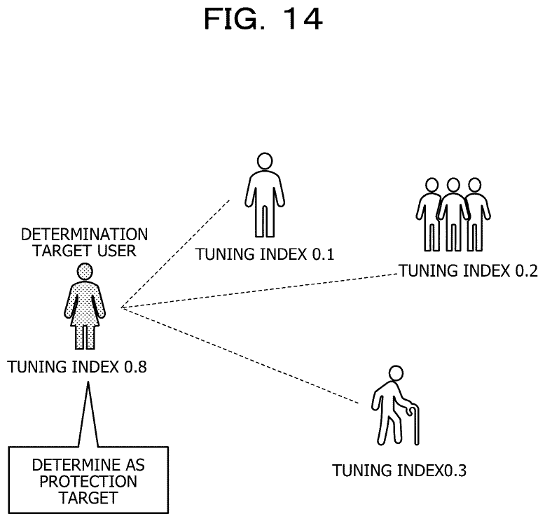

In addition, the protection determination unit 24 detects a user who may not detect another user having a similar tuning index as an isolated protection target user. FIG. 14 is a diagram illustrating a detection of a protection target user. As illustrated in FIG. 14, the protection determination unit 24 sets a determination target user as a protection target when a user having a tuning index whose difference is less than a threshold value may not be detected with respect to a determination target user having a tuning index of “0.8”.

Similar to FIG. 13, the protection determination unit 24 may use the relationship between users as a determination material. For example, since it is considered that a protection target user having a higher relationship has a stronger sense of alienation, the protection determination unit 24 may add the importance of protection of the protection target user according to the relationship. As described above, since the protection determination unit 24 detects and lists the protection target users, the administrator or the like may follow up the protection target users, and measures to reduce sense of alienation and to post opinions may be considered even in a case of the minority.

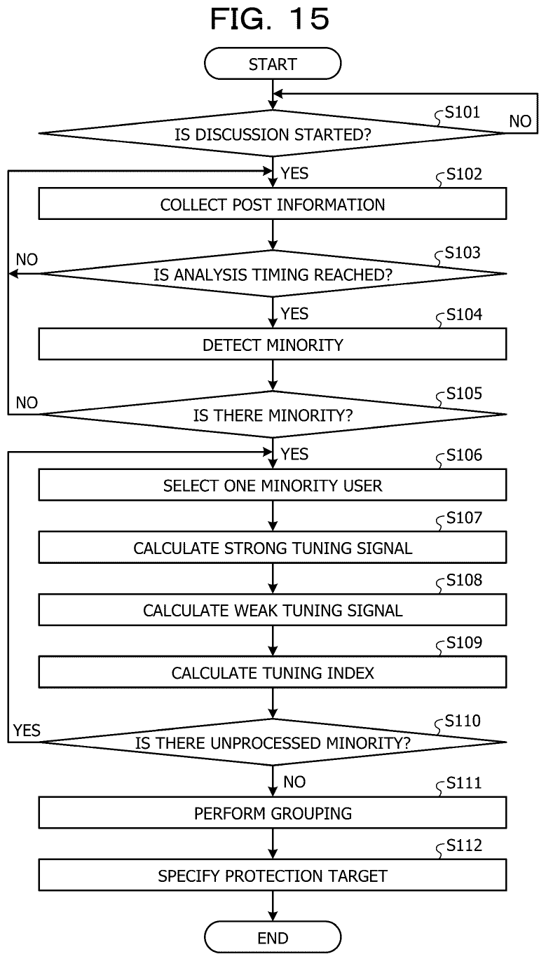

Next, an example of a flow of a series of processes from the user detection of the minority to the detection of the protection target user will be described. FIG. 15 is a flowchart illustrating a flow of processes according to the first embodiment. Note that the order of the steps in the flowchart may be changed within a range in which there is no inconsistency.

As illustrated in FIG. 15, when a discussion is started (S101: Yes), the control unit 20 of the information processing apparatus 10 collects post information including an opinion posted by each user himself/herself, agreement information in which each user agrees with opinions of other users, and the like, and stores the post information in a post information DB 15 (S102).

Then, when the designated analysis timing is reached (S103: Yes), for example, when a designated time elapses from the start of the discussion or when the number of posts reaches a certain number or more, the control unit 20 reads the post information from the post information DB 15 and detects the minority users (S104).

Here, when the minority user is not detected (S105: No), the control unit 20 repeats the S102 and the subsequent steps. On the other hand, when the minority users are detected (S105: Yes), the control unit 20 selects one of the detected minority users (S106).

Then, the control unit 20 calculates a strong tuning signal for the selected minority user using Equations (1) to (4) (S107) and calculates a weak tuning signal for the selected minority user using Equations (5) to (6) (S108). After that, the control unit 20 calculates the tuning index of the selected minority using Equation (7) (5109).

Here, in a case where there is an unprocessed minority user (5110: Yes), the control unit 20 repeats the S106 and the subsequent for a next minority user. On the other hand, when there is no unprocessed minority user (5110 : No), the control unit 20 performs grouping of users having a common tuning stress using the tuning indexes of each minority user (S111), and specifies an isolated protection target user (S112).

As described above, the information processing apparatus 10 may generate a plurality of tendencies such as a strong tuning signal and a weak tuning signal with respect to a change in the index value indicating the degree of the positive emotion of each minority user. In addition, the information processing apparatus 10 may group users having the same tendency by comparing the plurality of tendencies. As a result, the information processing apparatus 10 may specify users having similar opinions.

In addition, the information processing apparatus 10 may calculate a strong tuning signal obtained by directly analyzing the opinion of the user and a weak tuning signal obtained by analyzing the reaction to the opinion of another person. As a result, the information processing apparatus 10 may perform grouping in consideration of both the positive aspect and the negative aspect of each user.

In addition, the information processing apparatus 10 may generate and output a list of strong tuning signals calculated for each user, a list of weak tuning signals calculated for each user, a list of grouping, a list of protection target users, and the like. As a result, the information processing apparatus 10 may output useful information that may be used for a measure for the administrator to activate the discussion, a measure for the administrator to protect the minority, and the like.

The data examples, numerical value examples, keyword examples, information of each DB, and the like used in the above-described embodiment are merely examples, and may be arbitrarily changed. In addition, in the above-described embodiment, the posting of the opinion using the SNS or the like has been described as an example, but the present disclosure is not limited thereto. For example, the information processing apparatus 10 may perform analysis similar to the above-described processing by performing morphological analysis, document analysis, or the like on the minutes documenting a discussion, voice data obtained by voice recording, or the like and specifying the opinion of each user. In this case, the information processing apparatus 10 may use, for example, a raise-hand, a back-up, a time until a reply to an opinion, or the like as the approval or disapproval of another person's opinion.

In the embodiment described above, the example has been described in which the information processing apparatus 10 identifies the minority user and then analyzes the minority user. However, the present disclosure is not limited to this example. For example, the information processing apparatus 10 may analyze all users who have performed posting.

In addition, the information processing apparatus 10 may calculate each tuning signal and each tuning index using only a change in the positive degree in the positive, and may calculate each tuning signal and each tuning index using only a change in the negative degree in the negative.

In addition, the information processing apparatus 10 may perform grouping of users and specifying protection target users by using any one of the strong tuning signal and the weak tuning signal. In the above-described embodiment, an example in which the information processing apparatus 10 uses the positive degree of the agreed opinion of another person in the calculation of the weak tuning signal has been described, but the present disclosure is not limited thereto. For example, the information processing apparatus 10 may use the positive degree of the opinion other than the opinion that is not agreed with by the target user among opinions of others. In addition, when the consent is divided into a plurality of levels, the information processing apparatus 10 may use the positive degree of the opinion of another person who has given consent at a predetermined level or higher.

In addition, in the above-described embodiment, an example in which the higher the numerical value is, the higher the positive degree is has been described. However, the present disclosure is not limited thereto, and the information processing apparatus 10 may adopt any information regardless of a format or the like as long as the information can express the positive degree. For example, even in a case where the higher the numerical value is, the higher the negative degree is, the information processing apparatus 10 may execute the analysis using the same processing as that in the above-described embodiment by using the absolute value or using sign conversion or the like. As a method of the sign conversion, for example, when the index value is a negative degree “−0.99”, the information processing apparatus 10 may adopt an analysis in which a minus negative degree (0.99) is set as a positive degree.

The information processing apparatus 10 may perform analysis using the negative degree instead of the positive degree. In addition, even in a case where the negative degree is set for the index value, the information processing apparatus 10 may perform the same analysis as that in the above-described embodiment by processing a negative degree with a negative value as a positive degree.

The processing procedures, control procedures, specific names, and information including various types of data and parameters described in the above description and illustrated in the drawings may be arbitrarily changed unless otherwise specified.

In addition, specific forms of distribution and integration of the constituent elements of each device are not limited to those illustrated in the drawings. For example, the first detection unit 22 and the second detection unit 23 may be integrated. For example, all or some of the constituent elements may be functionally or physically distributed or integrated in an arbitrary unit in accordance with various loads or use situations. Furthermore, all or any part of each processing function of each device may be realized by a CPU and a program analyzed and executed by the CPU, or may be realized as a hardware by wired logic.

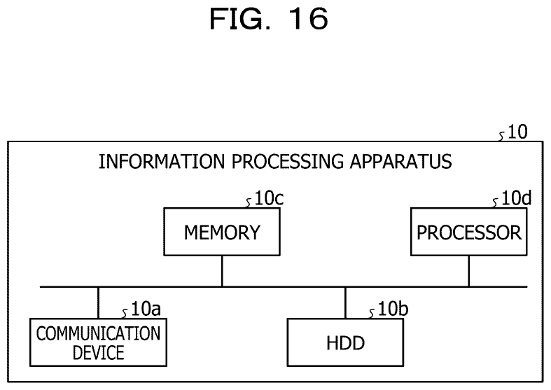

FIG. 16 is a diagram illustrating an example of a hardware configuration. As illustrated in FIG. 16, the information processing apparatus 10 includes a communication device 10a, a hard disk drive (HDD) 10b, a memory 10c, and a processor 10d. The units illustrated in FIG. 16 are coupled to each other via a bus or the like.

The communication device 10a is a network interface card or the like, and communicates with other devices. The HDD 10b stores a program for operating the functions illustrated in FIG. 3 and a DB.

The processor 10d reads a program for executing the same processing as that of each processing unit illustrated in FIG. 3 from the HDD 10b or the like and expands the program in the memory 10c, thereby operating a process for executing each function described in FIG. 3 or the like. For example, this process executes the same function as that of each processing unit included in the information processing apparatus 10. For example, the processor 10d reads a program having the same functions as those of the minority detection unit 21, the first detection unit 22, the second detection unit 23, the protection determination unit 24, and the like from the HDD 10b or the like. Then, the processor 10d executes a process for executing the same processing as the minority detection unit 21, the first detection unit 22, the second detection unit 23, the protection determination unit 24, and the like.

As described above, the information processing apparatus 10 operates as an information processing apparatus that executes the determination method by reading and executing the program. Further, the information processing apparatus 10 may read the program from a recording medium by a medium reading device and execute the read program to realize the same functions as those of the above-described embodiments. The other program described in the embodiments is not limited to being executed by the information processing apparatus 10. For example, the above-described embodiments may be similarly applied to a case where another computer or a server executes the program or a case where the another computer and the server execute the program in cooperation with each other.

This program may be distributed via a network such as the Internet. In addition, the program may be recorded in a computer-readable recording medium such as a hard disk, a flexible disk (FD), a compact disc read only memory (CD-ROM), an Magneto-Optical disk (MO), or a Digital Versatile Disc (DVD), and executed by being read from the recording medium by the computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a determination program causing a computer to execute a processing of:
determining, based on at least one of an opinion of respective users with respect to a specific topic and information regarding an approval or a disapproval of the respective users for an opinion of another person with respect to the specific topic, a tendency of a change in an index value indicating a degree of positive emotions of the users; and
outputting, when detecting a first tendency and a second tendency in which a difference between the first tendency and the second tendency is equal to or less than a threshold value, a first user corresponding to the first tendency and a second user corresponding to the second tendency from among the users as third users included in a target group.

2. The non-transitory computer-readable recording medium according to claim 1, further comprising:
calculating a variance using the index value which is specified based on a number of times the respective users gives the opinion to the specific topic, an interval at which the respective users gives the opinion to the specific topic, or a content of the opinion of the respective users to the specific topic; and
extracting, as the users, fourth users corresponding to an opinion of a minority in the specific topic from among target users who give an opinion to the specific topic based on the calculated variance.

3. The non-transitory computer-readable recording medium according to claim 1, further comprising:
determining, for each of a plurality of tendencies which are determined for each of the users, whether a tendency of another user in which a difference between the each of the plurality of users and the another user is equal to or less than the threshold value is detected; and
extracting, from the users, a fifth user for whom the tendency in which the difference between the fifth use and another user is equal to or less than the threshold value is not detected.

4. The non-transitory computer-readable recording medium according to claim 1, wherein the determining the tendency includes:
specifying, for each of the users, the index value based on a keyword included in the opinion of the respective users and a number of changes in the index value within a range indicating a positive opinion at each of regular time intervals in a case where the opinion of the respective users with respect to the specific topic is used; and
calculating the variance of the index value as a tendency of a change in the index value by using the index value and the number of changes in the index value at each of regular time intervals, and
the first user and the second user are output using the variance calculated for each of the users as the third users included in the target group.

5. The non-transitory computer-readable recording medium according to claim 1, wherein the determining the tendency includes:
specifying, for each of the users, the index value based on a keyword included in the opinion of the respective users and a number of changes in the index value within a range indicating a positive opinion from a negative opinion within a period of time in a case where the opinion of the respective users with respect to the specific topic is used; and
calculating the variance of the index value as a tendency of a change in the index value by using the index value and the number of changes in the index value at each period of time, and
the first user and the second user are output using the variance calculated for each of the users as the third users included in the target group.

6. The non-transitory computer-readable recording medium according to claim 1, wherein the determining the tendency includes:
specifying, for each of the users, the index value based on a total number of opinions of the users and a keyword included in the opinion of the another person which the respective users approves and a number of changes in the index value within a range indicating a positive opinion from a negative opinion within a period of time in a case where the information regarding the approval or the disapproval of the respective users for the opinion of another person with respect to the specific topic is used; and
calculating the variance of the index value as a tendency of a change in the index value by using the index value and the number of changes in the index value at each period of time, and
the first user and the second user are output using the variance calculated for each of the users as the third users included in the target group.

7. A determination method comprising:
determining, based on at least one of an opinion of respective users with respect to a specific topic and information regarding an approval or a disapproval of the respective users for an opinion of another person with respect to the specific topic, a tendency of a change in an index value indicating a degree of positive emotions of the users; and
outputting, when detecting a first tendency and a second tendency in which a difference between the first tendency and the second tendency is equal to or less than a threshold value, a first user corresponding to the first tendency and a second user corresponding to the second tendency from among the users as third users included in a target group.

8. An information processing apparatus comprising:
a memory; and
a processor couples to the memory and configured to:
determine, based on at least one of an opinion of respective users with respect to a specific topic and information regarding an approval or a disapproval of the respective users for an opinion of another person with respect to the specific topic, a tendency of a change in an index value indicating a degree of positive emotions of the users; and
output, when detecting a first tendency and a second tendency in which a difference between the first tendency and the second tendency is equal to or less than a threshold value, a first user corresponding to the first tendency and a second user corresponding to the second tendency from among the users as third users included in a target group.
